(19) United States
(12) Patent Application Publication
(10) Pub. No.: US 2006/0166172 A1
(43) Pub. Date: Jul. 27, 2006

(54) Speaking words language instruction system and methods

(76) Inventor: Allegra A. May, Portsmouth, NH (US)

Correspondence Address: SCOTT C. RAND, ESQ.;MCLANE, GRAF, RAULERSON & MIDDLETON, PA, 900 ELM STREET, P.O. BOX 326, MANCHESTER, NH, 03105-0326, US

(21) Appl. No.: 10/676,509

(22) Filed: Oct. 1, 2003

Related U.S. Application Data
(60) Provisional application No. 60/415,086, filed on Oct. 1, 2002.

(51) Int. Cl. G09B 19/04

(52) U.S. Cl. 434/185; 434/307 R

(57) ABSTRACT

A computer-based information handling system comprises a processor for executing an application program, audio output device, and video display device including a display screen for displaying a word in a language for audible playback. A pointing device controls a cursor movable on the display screen in response to a user operating the pointing device. A memory is provided for storing a digital recording of the word for audible playback and a rollover region is associated with the word for playback, defined at a position on the display screen overlapping a position of said word for playback on the display screen. The rollover region is configured to cause audible playback of the word in the on-screen language when at least a portion of the cursor is moved over the rollover region. In further aspects, a method, computer-readable medium, language instruction system, markup language document, and method for developing a language instruction system are also provided.

### CROSS-REFERENCE TO RELATED APPLICATION

This application claims the benefit under 35 U.S.C. §119(e) of U.S. provisional application Ser. No. 60/415,086 filed Oct. 1, 2002 (Attorney Docket No. 3359.1001-000). Said provisional application is incorporated herein by reference in its entirety.

### BACKGROUND OF THE INVENTION

The present invention is directed to a language instruction tool and, more particularly, to a computer-based system and method employing an improved “speaking words” interface for teaching and promoting early or emergent reading and/or foreign language acquisition. Although the present invention will be described primarily herein in reference to an application designed to run primarily from a browser as a set of hypertext markup language (HTML), or World Wide Web (Web) documents or pages, it will be recognized that the present invention can also be embodied as other markup language documents or run as a standalone application, such as a Macromedia Flash (SWF) file on the user's desktop. Thus, the present invention may be accessed directly from the Internet or intranet, or can be distributed to users by any computer distribution mechanism, including CD-ROM and DVD, and the like.

Historically, sound has been implemented in Web browsers in very limited ways, often requiring the user to click and then wait for a significant interval of time (possibly up to a second or longer) until the sound was downloaded. When a faster response was available, the clicking sound of the mouse interfered with hearing the sound. Too often the sound quality was poor or unexpressive. Most embedded sounds on the Web could not be played by a universal player, so pages that ran on one user's platform would not run on another.

The present invention provides a new and improved language instruction method and apparatus that overcomes the above referenced problems and others.

### SUMMARY OF THE INVENTION

In a first aspect, a computer-based information handling system includes a processor for executing an application program and a video display device including a display screen for displaying a word in a first language for audible playback on the display screen. A pointing device controls the position of a cursor movable on the display screen of the video display device in response to a user operating the pointing device and an audio output device is provided for audio playback. A memory stores a digital recording of the word for audible playback and a rollover region is associated with the word for playback and is defined at a position on the display screen overlapping a position of the word for playback on the display screen and configured to cause audible playback of the word in the first language when at least a portion of the cursor is over the rollover region.

In a second aspect, a method implemented in a computer-based information handling system having a video display, an audio output device for audio output of prerecorded sounds, a pointing device for positioning a cursor on the video display, comprises the steps of providing a background image viewable on the video display, wherein the background image includes a word in a first language and prerecording a digital sound recording of the word being spoken in the first language. A designated hot region on the video display for triggering audio output of the recording of the word in the first language, is associated with the word and overlaps the word on the video display. When at least a portion of the cursor is positioned over the hot region in response to a user using the pointing device, the audio output device is caused to audibly output the recording of the word in the first language in response to the cursor or portion thereof being positioned over the hot region.

In a third aspect, a computer-readable medium whose contents cause a computer-based information handling system to perform method steps for audio playback of a word appearing on a display device of the information handling system is provided. The method steps include providing a background image viewable on the display device, the background image including a word in a first language, and prerecording a digital sound recording of the word being spoken in the first language. A designated hot region on the display device is associated with the on-screen word for triggering audio output of the recording of the word in the first language, the hot-region overlapping the word on the display device. When at least a portion of the cursor is positioned over the hot region in response to a user using the pointing device, the audio output device is caused to audibly output the recording of the word in the first language in response to the cursor or portion thereof being positioned over the hot region.

In a fourth aspect, a language instruction system is provided, comprising a processor for executing an application program and a video display device including a display screen for displaying a word in a first language for audible playback on the display screen, the word appearing individually or as a part of a multiword phrase or sentence. A pointing device controls a cursor movable on the display screen of the video display device in response to a user operating the pointing device and an audio output device is provided for audio playback. A memory stores a digital recording of the word for audible playback and a rollover region is associated with the word for playback and defined at a position on the display screen overlapping a position of the word for playback on the display screen and configured to cause audible playback of the word in the first language when at least a portion of the cursor is over the rollover region. A first on-screen object is selectable with the pointing device and associated with the multiword phrase or sentence displayed on the display screen, the first on-screen object configured to trigger audio playback of the multiword phrase or sentence in the first language. If the word is a part of a multiword phrase or sentence, a second on-screen object is provided which is selectable with the pointing device and associated with the multiword phrase or sentence displayed on the display screen, the first on-screen object configured to trigger audio playback of the multiword phrase or sentence in a second language and in a fluently spoken manner.

In a fifth aspect, a method for developing a language instruction system, comprises designing a spoken words interface having a background image and text of one or more words for audible playback. A digital image representation of the background and a digital sound recording of the one or more words for audible playback are created. For each of the one or more words, a button, e.g., a transparent button, is provided on the spoken words interface and at least a portion of the imported audio file is associated with the button so as to cause audible playback of the at least a portion of the imported audio file in response to user input comprising positioning at least a portion of an on-screen cursor over the button. Each button is placed on the spoken words interface at an on-screen location which at least partially overlies an on-screen location of its associated word.

In a sixth aspect, a markup language document stored on a computer-readable medium to provide interactive language instruction includes a background comprising a background image viewable on the video display, the background image including a word in a first language, and a prerecorded digital sound recording of the word being spoken in the first language. A rollover region on the video display triggers audio output of the recording of the word in the first language in response to a user moving at least a portion of an on-screen cursor over the rollover region, the rollover region overlapping the word on the video display.

One advantage of the present invention resides in its ability to combine visual and auditory language learning.

Another advantage of the present invention is found in that it enables users to learn languages directly over the Internet, intranet, or computer desktop.

Another advantage of the present invention is that it provides users with the opportunity to play each word as many times as they want.

Yet another advantage of the present invention is found in its ability to produce sound instantly.

Still another advantage of the present invention is that words may be played with no mouse click to interfere with the sound of a word.

Another advantage of the present invention resides in that high quality sound, pronunciation, and intonation may be provided.

Still another advantage of the present invention is found in that it may be adapted to play on virtually all Web browsers using a widely or universally available player.

Still further benefits and advantages of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a block diagram illustrating a web browser-based embodiment of the present invention.

FIG. 2 is a block diagram of a hardware system generally representative of a computer-based information handling system of a type operable to embody the present invention.

FIGS. 3-5 illustrate exemplary web page layouts incorporating the speaking words interface in accordance with the present invention.

FIGS. 6-9 are flow diagrams illustrating some exemplary methods of operation of the present invention.

FIG. 10 is a flow diagram illustrating an exemplary manner for generating a speaking words file in accordance with the present invention.

### DETAILED DESCRIPTION OF THE PREFERRED EMBODIMENTS

The present invention is preferably implemented in a web page comprising one or more words of text and specifically designed such that, when the user rolls the mouse over a word of text, the user hears the word spoken in a natural, authentic accent. The Speaking Words web page may additionally include symbols that the user can click on to hear a whole phrase or sentence spoken fluently.

Foreign language applications of the present invention will generally employ the foreign language (i.e., a secondary language) as the on-screen language as well as the rollover playback language. A designated on-screen symbol may also be provided to allow the user to hear the meaning of a word, phrase or sentence in their native language (i.e., primary language), e.g., via a mouse click.

Although the present invention is particularly suited to foreign language applications, it will be recognized that the present invention may also be to provide mouse rollover playback of a spoken word in a web browser in the context of learning a primary or secondary language, including but not limited to emergent reading, English for speakers of other languages (ESL) training, secondary language training, language dictionaries, language tests, language pages for learning-disabled students, or other voice or speech training or coaching applications.

Furthermore, although the present invention will be described primarily herein by way of reference to a personal computer equipped with a web browser, it will be recognized that the present invention may be implemented in any type of computer-based information handling system, including but not limited to general purpose or personal computers, workstations, hand-held computers, convergence systems, information appliances, Internet appliances, Internet televisions, Internet telephones, personal digital assistants (PDAs), personal information managers (PIMs), portable communication devices such as portable or mobile telephones, hand-held devices, PDAs, or the like, having a wired or wireless network connection or capability, web browser (including wireless web browser) equipped devices, communication devices having embedded audio systems, and so forth.

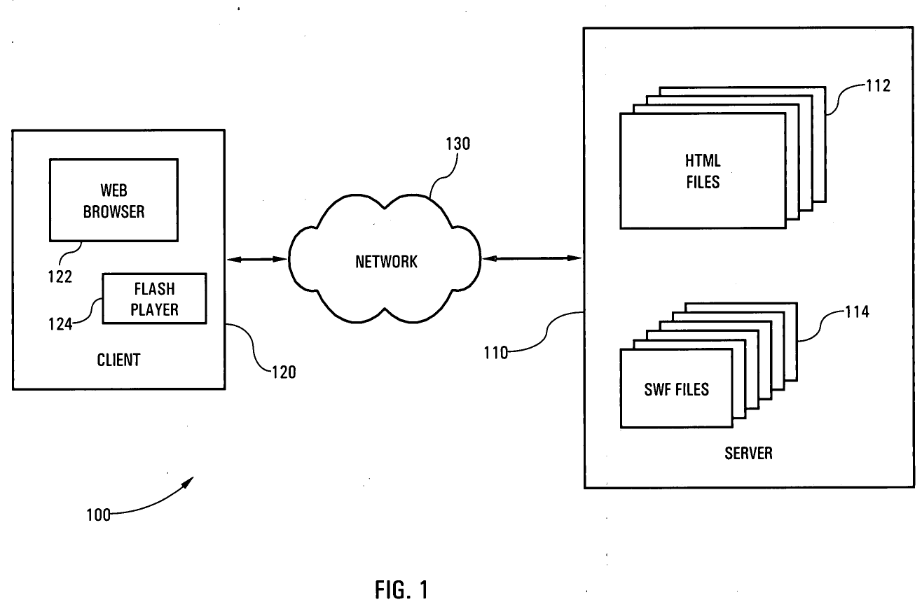

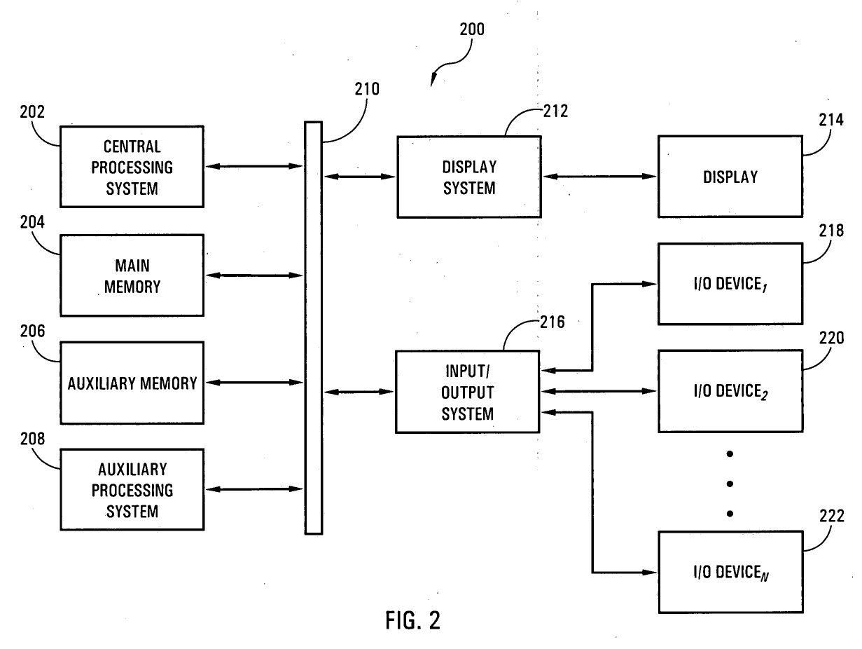

With reference to FIG. 1, a block diagram depicting an exemplary networked information handling system 100 in accordance with a preferred, web browser-based embodiment of the present invention is shown. The information handling system 100 includes one or more network servers 110 interconnected with one or more remotely located client computer systems 120 configured to allow a user to use a web browser 122 over a network 130. The client computer system 120 and server computer system 110 may be, for example, a computer-based information handling system as described below by way of reference to FIG. 2.

The network 130 interconnecting server 110 and the remote client system 120 can include, for example, a local area network (LAN), metropolitan area network (MAN), wide area network (WAN), and the like, and interconnections thereof. Network connection 130 can be an Internet connection made using the World Wide Web, an intranet connection, or the like.

The server computer system 110 and client computer system 112 interact by exchanging information via communications link 130, which may include transmission over the Internet. In the depicted, web browser-based embodiment, the server 112 receives hypertext transfer protocol (HTTP) requests to access web pages identified by uniform resource locators (URLs) and provides the requested web pages to the client computer system 120 for display using the browser 122, as is generally known in the art.

To execute the language instruction program in accordance with the present invention, a user operates the client computer system 120. The client computer system 120 operates web browser software 122 that allows the user to download and display one or more HTML files, or web pages, 112 contained on the server computer system 110.

The present invention is preferably implemented using Macromedia's Flash application; although other implementations are also contemplated, such as JavaScript and Java. Each speaking words web page in accordance with this teaching consists of the one or more HTML pages 112 and one or more associated Flash format (SWF) files 114.

Each of the web pages 112 includes one or more SWF files 114. The SWF files are contained in the HTML pages 112 as embedded data, e.g., as an object and/or embedded file. When the user views the speaking words pages 112, the HTML pages and associated SWF files are downloaded from the server 110 to the user's client computer 112. In the preferred embodiment, the Flash Player 124 is installed in the browser 122 or on the client computer 112 desktop to provide audio playback of the speaking words pages 112.

Preferably, the speaking word files 112 of the present invention are adapted to provide universal or near universal browser support, although it is also contemplated that certain implementations may be targeted to run in a specific browser, such as Microsoft's Internet Explorer browser (e.g., version 5.5 or higher). Additionally, the speaking words files 112 may be implemented in a host of other programming languages (such as Java) and/or run as a stand-alone application, or client/server or thin client application. Likewise, the present invention may be implemented using an audio player other than the Flash player. Also, it is contemplated that other markup languages or future versions of the HTML specification may support sound directly, in which case it is unnecessary to implement the sound files as embedded data and that the sound file would be played under direct markup language support, for example, new HTML tags to play audio.

Referring now to FIG. 2, an information handling system operable to embody the present invention is shown. The hardware system 200 shown in FIG. 2 is generally representative of the hardware architecture of a computer-based information handling system of the present invention, such as the client computer system 120 or the server computer system 110 of the networked system 100 shown in FIG. 1.

The hardware system 200 is controlled by a central processing system 202. The central processing system 202 includes a central processing unit such as a microprocessor or microcontroller for executing programs, performing data manipulations and controlling the tasks of the hardware system 200. Communication with the central processor 202 is implemented through a system bus 210 for transferring information among the components of the hardware system 200. The bus 210 may include a data channel for facilitating information transfer between storage and other peripheral components of the hardware system. The bus 210 further provides the set of signals required for communication with the central processing system 202 including a data bus, address bus, and control bus. The bus 210 may comprise any state of the art bus architecture according to promulgated standards, for example industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on.

Other components of the hardware system 200 include main memory 204, and auxiliary memory 206. The hardware system 200 may further include an auxiliary processing system 208 as required. The main memory 204 provides storage of instructions and data for programs executing on the central processing system 202. The main memory 204 is typically semiconductor-based memory such as dynamic random access memory (DRAM) and/or static random access memory (SRAM). Other semi-conductor-based memory types include, for example, synchronous dynamic random access memory (SDRAM), double data rate (DDR) SDRAM, Rambus dynamic random access memory (RDRAM), ferroelectric random access memory (FRAM), and so on. The auxiliary memory 206 provides storage of instructions and data that are loaded into the main memory 204 before execution. The auxiliary memory 206 may include semiconductor-based memory such as read-only memory (ROM), programmable read-only memory (PROM), erasable programmable read-only memory (EPROM), electrically erasable programmable read-only memory (EEPROM), or flash memory (block oriented memory similar to EEPROM). The auxiliary memory 206 may also include a variety of nonsemiconductor-based memories, including, but not limited to, magnetic tape, drum, floppy disk, hard disk, optical laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), etc. Other varieties of memory devices are contemplated as well.

The hardware system 200 may optionally include an auxiliary processing system 208 which may include one or more auxiliary processors to manage input/output, an auxiliary processor to perform floating point mathematical operations, a digital signal processor (a special-purpose microprocessor having an architecture suitable for fast execution of signal processing algorithms), a back-end processor (a slave processor subordinate to the main processing system), an additional microprocessor or controller for dual or multiple processor systems, or a coprocessor. It will be recognized that such auxiliary processors may be discrete processors or may be built in to the main processor.

The hardware system 200 further includes a display system 212 for connecting to a display device 214, and an input/output (I/O) system 216 for connecting to one or more I/O devices 218, 220, up to N number of I/O devices 222. The display system 212 may comprise a video display adapter having all of the components for driving the display device, including video memory, buffer, and graphics engine as desired. Video memory may be, for example, video random access memory (VRAM), synchronous graphics random access memory (SGRAM), windows random access memory (WRAM), and the like.

The display device 214 may comprise a cathode ray-tube (CRT) type display such as a monitor or television, or may comprise an alternative type of display technology such as a projection-type display, liquid-crystal display (LCD), light-emitting diode (LED) display, gas or plasma display, electroluminescent display, vacuum fluorescent display, cathodoluminescent (field emission) display, plasma-addressed liquid crystal (PALC) display, high-gain emissive display (HGED), and so forth.

The input/output system 216 may comprise one or more controllers or adapters for providing interface functions between the one or more I/O devices 218-222. For example, the input/output system 216 may comprise a serial port, parallel port, integrated device electronics (IDE) interfaces including AT attachment (ATA) IDE, enhanced IDE (EIDE), and the like, small computer system interface (SCSI) including SCSI-1, SCSI-2, SCSI-3, ultra SCSI, fiber channel SCSI, and the like, universal serial bus (USB) port, IEEE 1394 serial bus port, infrared port, network adapter, printer adapter, radio-frequency (RF) communications adapter, universal asynchronous receiver-transmitter (UART) port, etc., for interfacing between corresponding I/O devices such as a keyboard, mouse, track ball, touch pad, digitizing tablet, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, etc.

The input/output system 216 and I/O devices 218-222 may provide or receive analog or digital signals for communication between the hardware system 200 of the present invention and external devices, networks, or information sources. The input/output system 216 and I/O devices 218-222 preferably implement industry promulgated architecture standards, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It should be appreciated that modification or reconfiguration of the hardware system 200 of FIG. 2 by one having ordinary skill in the art would not depart from the scope or the spirit of the present invention.

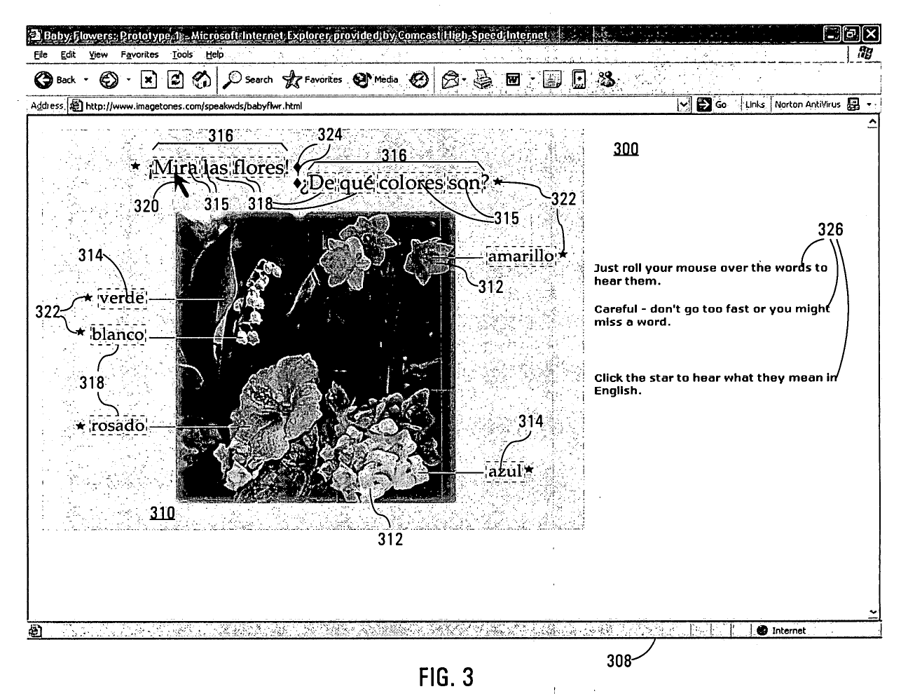

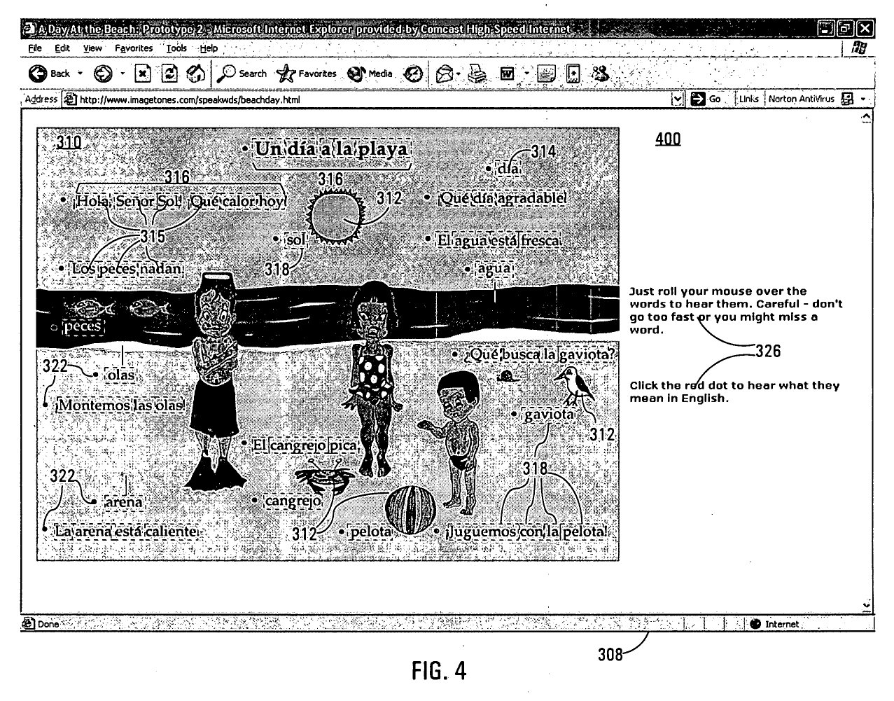

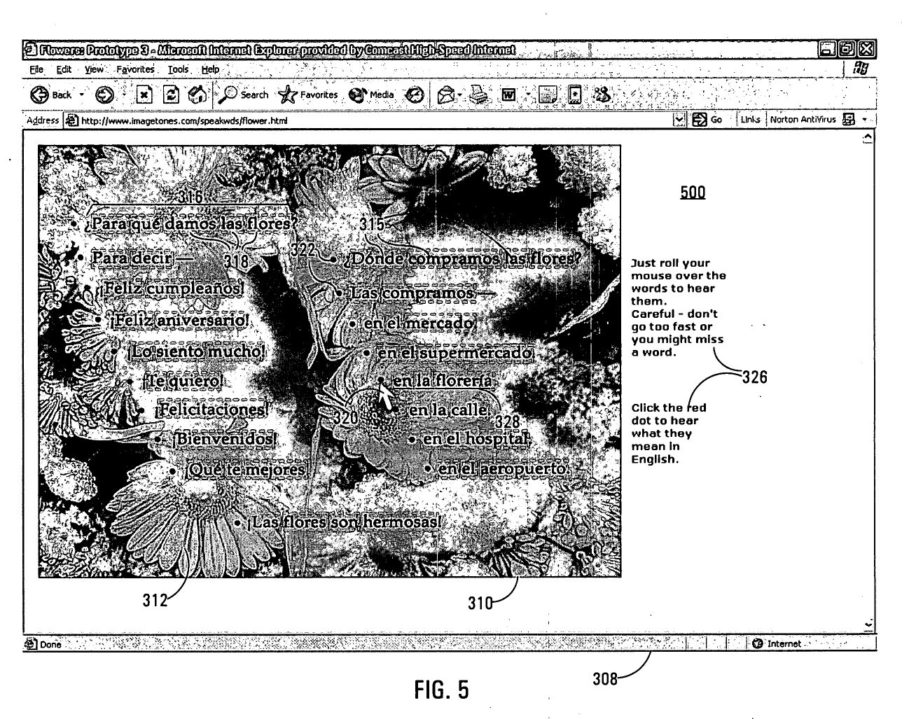

Referring now to FIGS. 3-5, there appears three exemplary user interfaces 300, 400, and 500, respectively, and wherein like reference numerals will be used to describe like or analogous components throughout the several views, each of which includes a viewable on-screen image or graphic 310. The background image 310 is preferably a static image, such as a GIF, JPEG, bitmapped, TIFF image, or the like, and preferably a JPEG image. The background image contains one or more objects of interest 312, e.g., bearing on the learning objectives and language instruction provided. In the depicted illustrations of the preferred embodiments, the speaking works interfaces are shown contained in a web browser window 308. However, it will be recognized that the speaking words interfaces 300, 400, and 500 are also amenable to other application environments.

The user interface further includes text, which may be on-screen text, e.g., overlaying the background 310, or which may be a part of the image forming the background 310. The text may include one or more individual words 314 and/or words 315 forming part of a multiword phrase or sentence 316. The background 310, in certain embodiments, may include viewable objects or renderings 312 which typically depict or have a direct or indirect (e.g., thematic) relationship to the words, phrases, and/or sentences to be read, learned and/or pronounced by the user.

Each of the textual words, whether an individual word 314 or a individual word 315 forming a part of a multiword phrase or sentence 316, has an associated mouse rollover region 318 (shown in broken lines) which has an at least partially overlapping position on the display screen as its associated word 314 or 315.

In a preferred embodiment, the rollover region 318 and its associated word 314 or 315, are substantially coextensive, e.g., the mouse rollover region is defined by a rectangular box equal in size to and enclosing its associated word. In a particularly preferred embodiment, the mouse rollover region is defined by a rectangular box with top and side boundaries that are aligned with the top and sides of its associated word and a bottom boundary that extends a predetermined number of pixels below the bottom of the associated word, e.g., 1-10 pixels, preferably 2-5 pixels, and most preferably, 2 pixels. In this manner, in the case of a standard, upward pointing cursor 320, the pointed portion of the cursor 320 may move over the portion of the rollover region downwardly extending from the bottom edge of the associated word 314 or 315 allowing the user to essentially point to a word 314 or 315 for playback without visually obscuring the word.

In operation, a user controls a mouse or other pointing device to move an on-screen cursor or pointer 320 over a selected word 314 or 315 to trigger prerecorded and correctly pronounced audio playback of the selected word.

Optionally, additional on-screen symbols, objects, indicia, or buttons 322 may be provided, responsive to mouse button events. The buttons 322 may be selected using mouse button events, e.g., by clicking, to trigger audio playback of an associated word 314 or 315. A button 322 may be associated with words 314 which are not a part of a multiword phrase or sentence to cause playback, when selected, of the word in a second language, i.e., a language other than language in which the word appears in the on-screen text. Likewise, a button 322 may be associated with an entire multiword phrase 316, in which case, selecting the button will cause playback of the entire phrase or sentence in the second language. In a preferred embodiment, bilingual playback buttons 322 are provided for individual words 315 and for entire multiword phrases or sentences 316, but not for individual words 315 that form part of a multiword phrase or sentence.

In another preferred embodiment, where bilingual playback is provided via on-screen buttons, the on-screen text and the audio triggered by mouse rollover events are provided in a language which is foreign to or is being learned by the user (secondary language), whereas the translated audio triggered by the buttons 322 is in the user's native (primary) language. However, other variations are also contemplated. For example, in the case of teaching a user to read or teaching speech skills, vocal training, or the like, the on-screen text and rollover event triggered audio may be in the user's primary language.

A second, on-screen indicia, object, button, etc., 324 may also be provided for fluency playback, i.e., for playback of an entire multiword phrase or sentence 316 in the on-screen language in a fluently spoken manner, which oftentimes cannot be adequately garnered from hearing words spoken individually and distinctly. Thus, where the text includes a multiple word phrase or sentence 316, a fluency object 324 may be provided to trigger audible playback of the entire phrase or sentence in the language of the on-screen text spoken in a fluent, continuous manner. Additional on-screen text 326, such as user instructions (i.e., in the user's primary language in the case of bilingual language instruction) or other information may also be provided.

Additional on-screen actions may also be provided, such as underlining 328 of the words spoken during playback, e.g., underlining single words 314 of 315 during playback of an individual word and/or underlining an entire phrase or sentence during bilingual and/or fluency playback. As an alternative or in addition to underlining, other actions may also occur on playback, such as highlighting, a change of text color, other text effects, and the like.

As an alternative to the use of multiple types of on-screen indicia 322 and 324 for audio playback in the user's native language and the on-screen language, respectively, a single graphical object may be provided to provide playback in one of multiple languages or formats based on different mouse events, such as single click, double click, right or left mouse clicks, or through the use of pop-up or context menus.

It will be recognized that the cursor movement or coordinate data and mouse button event data as discussed herein need not generated by a mouse, but may be generated by any pointing device of a type used to the position of a cursor or pointer on a display screen, including but not limited to track ball, touch pad, digitizing tablet, joystick, track stick, touch screen, stylus, and so forth. In a preferred embodiment, the present invention is implemented for use with a touch screen, wherein the MouseOver events may be generated by a user stylus or finger touch down event at a coordinate position corresponding to a designated rollover region and/or by a touch down event occurring elsewhere on the screen followed by movement of the user's over a designated rollover region.

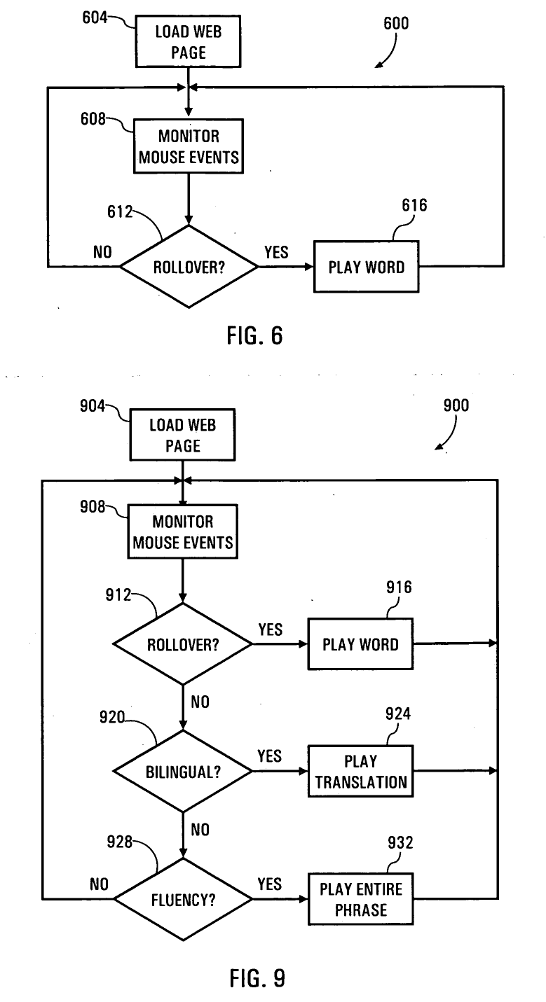

In operation, the speaking words program is a straightforward, event-driven application. Referring now to process 600 of FIG. 6, the user accesses spoken word web pages in accordance with the present invention at step 604. The user operates a mouse or other pointing device to move an on-screen pointer or cursor over the on-screen words they want to hear. In this manner, the user can play the words in any order and as many times as they want (this mimics the self-directed way in which young children sound out text on a printed page). Mouse position and events are monitored at step 608 and at step 612 it is determined whether a mouse rollover event has occurred. If a rollover event is not detected at step 612, the process returns to step 608 and repeats. If a mouse rollover event is detected at step 612, i.e., the on-screen pointer or cursor passes over a rollover region associated with a particular word, a recording of the word spoken in on-screen language (i.e., the language in which the word appears on the screen) is played at step 616. The process then returns to step 608 and repeats.

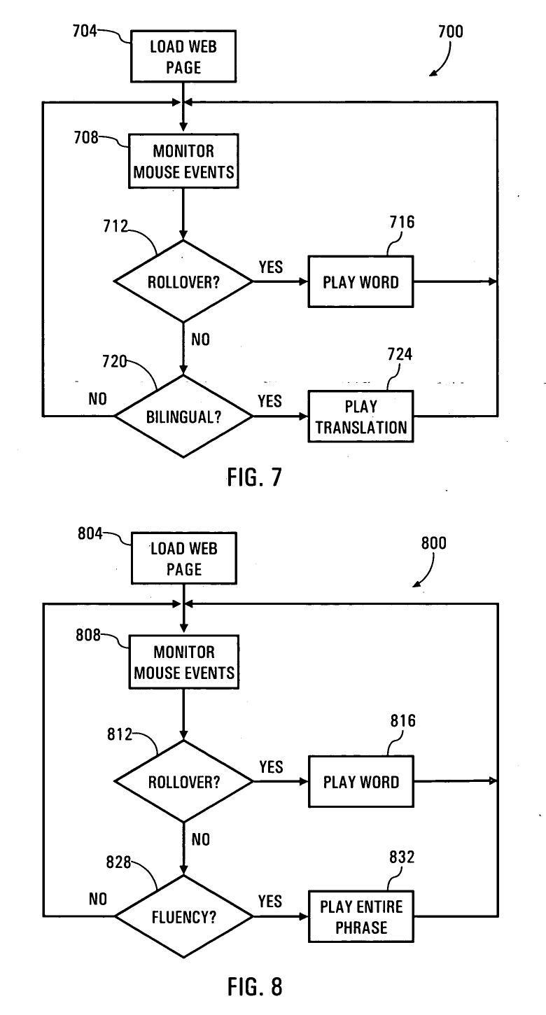

Referring now to FIG. 7, there appears a process 700 similar to the process 600 of FIG. 6, but further including an optional bilingual feature wherein where an on-screen object is provided for triggering playback of a bilingual recording, e.g., translation, of the on-screen text. The process 700 begins at step 704 in which the user accesses spoken word web pages as described above. Mouse position and events are monitored at step 708 and at step 712 it is determined whether a mouse rollover event has occurred. If a rollover event is not detected at step 712, the process returns to step 708 and repeats. If a mouse rollover event is detected at step 712, a recording of the word spoken in on-screen language is played at step 716. The process then returns to step 708 and repeats.

If a rollover event is not detected at step 712, it is determined at step 720 whether a mouse event that triggers playback of a bilingual recording has occurred. This may be, for example, a mouse button event or click on an on-screen button, icon, etc., proximate to an on-screen word, phrase, or sentence. If a bilingual mouse event is detected at step 720, a recording of the bilingual version or translation of the word or words associated with the selected on-screen object (typically in the user's primary language) is played at step 724 and the process returns to step 708 and repeats. If a bilingual mouse event is not detected at step 720, the process returns to step 708 and repeats.

In a preferred embodiment, only a single on-screen object is provided for a given word or group of words. That is, when a bilingual triggering object is associated with a multiword phrase or sentence, triggering bilingual playback at step 724 will cause playback of the entire multiword phrase or sentence. Thus, it is not necessary to provide on-screen objects for triggering bilingual playback of individual words within a multiword phrase or sentence, although doing so is contemplated. Of course, where the onscreen text is a single word, bilingual playback at step 724 will likewise consist of a single word. It is also contemplated that audio playback in multiple languages, in addition to the on-screen language, may be provided. Thus, a single speaking words page in accordance with the present invention may contain a set of translations in different languages, e.g., wherein a desired translation language is dynamically selected, e.g., in accordance with user input or information requested by the user.

Referring now to FIG. 8, there appears a process 800 similar to the process 600 of FIG. 6, but further including an optional fluency feature wherein where an on-screen object is provided for triggering playback of a an entire multiword phrase or sentence in the on-screen language so that the user can hear the entire phrase or sentence spoken in a fluent manner, since the correct pronunciation of words in a given phrase cannot always be ascertained from pronunciation of the words in isolation.

The process 800 begins at step 804 in which the user accesses spoken word web pages as described above. Mouse position and events are monitored at step 808 and at step 812 it is determined whether a mouse rollover event has occurred. If a rollover event is not detected at step 812, the process returns to step 808 and repeats. If a mouse rollover event is detected at step 812, a recording of the word spoken in on-screen language is played at step 816. The process then returns to step 808 and repeats.

If a rollover event is not detected at step 812, it is determined at step 828 whether a mouse event triggering playback of a fluent recording of an entire on-screen phrase or sentence has occurred. This may be, for example, a mouse button event or click on an on-screen button, icon, etc., proximate to an on-screen multiword phrase or sentence. A fluency icon need not be provided for on-screen text appearing as a single word rather than as part of a multiword phrase or sentence. If a fluency mouse event is detected at step 828, a recording of the entire phrase or sentence in the language of the text appearing on-screen is played at step 832 and the process returns to step 808 and repeats. If a fluency mouse event is not detected at step 828, the process returns to step 808 and repeats.

Referring now to FIG. 9, there is shown another embodiment of the present invention which incorporates both of the optional bilingual and fluency features, as discussed above. The process 900 begins at step in which the user accesses spoken word web pages as described above. Mouse position and events are monitored at step 908 and at step 912 it is determined whether a mouse rollover event has occurred. If a rollover event is not detected at step 912, the process returns to step 908 and repeats. If a mouse rollover event is detected at step 912, a recording of the word spoken in on-screen language is played at step 916. The process then returns to step 908 and repeats.

If a rollover event is not detected at step 912, it is determined at step 920 whether a mouse event triggering playback of a bilingual recording has occurred. This may be, for example, a mouse button event or click on an on-screen button, icon, etc., proximate to an on-screen word, phrase, or sentence. If a bilingual mouse event is detected at step 920, a recording of the bilingual version or translation of the word or words associated with the selected on-screen object is played at step 924 and the process returns to step 908 and repeats.

If a bilingual mouse event is not detected at step 920, the process proceeds to step 928 where it is determined whether a mouse event triggering playback of a fluent recording of an entire on-screen phrase or sentence has occurred. This may be, for example, a mouse button event or click on an on-screen button, icon, etc., proximate to an on-screen multiword phrase or sentence. A fluency icon need not be provided for on-screen text appearing as a single word rather than as part of a multiword phrase or sentence. If a fluency mouse event is detected at step 928, a recording of the entire phrase or sentence in the language of the text appearing on-screen is played at step 932 and the process returns to step 908 and repeats. If a fluency mouse event is not detected at step 928, the process returns to step 908 and repeats.

The processes outlined in FIGS. 6-9 illustrate some exemplary processes according to the present invention. In each of the depictions, the process is shown as a continuous loop and it will be recognized that the process may be terminated by closing the selected web page or instance of the browser application containing the web page, or by navigating away from the selected web page. The user may decide to repeat the process by loading additional web pages, e.g., by navigating to another web page, such as a next or previous page where multiple pages are sequenced or otherwise linked, e.g., by clicking on an icon, button, link, or other navigation device.

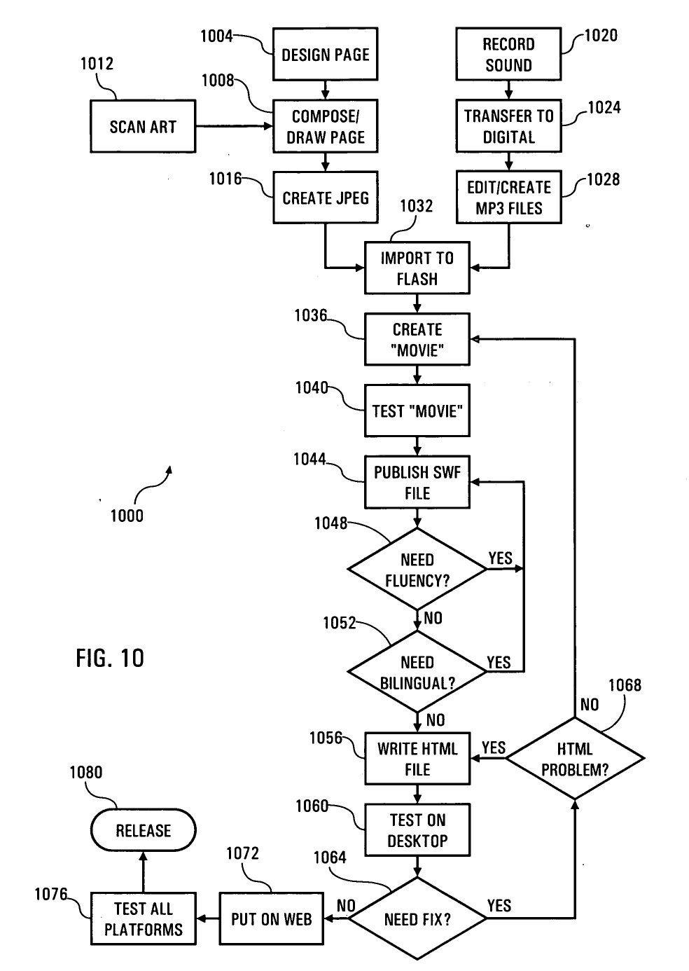

An exemplary process to develop a speaking words page in accordance with the present invention includes four distinct tasks: (1) creating JPEG images; (2) recording, transferring, and editing sound; (3) creating Flash SWF files; and (4) coding HTML pages. An exemplary method 1000 for generating or developing a speaking words file in accordance with the present invention is outlined in FIG. 10.

Although the present invention is described by way of reference to some of the presently preferred implementations, it will be appreciated that the described process is also amenable to other computer applications providing sound support and for creating sound and images on the Web, such as JavaScript, Java, and so forth.

1. The JPEG Image.

The first step (1004) in creating the JPEG image is to design a speaking words web page. Factors to be addressed include the total number of web pages to be generated and the appropriate text size or spacing between words for the intended audience or for ease of use. For example, it may be desirable to use larger text and larger spacing between words where the targeted audience includes younger children or persons not prone to precise mouse/cursor manipulations. Other considerations include the number of words appearing on the page, the number of separate SWF files to comprise the playable words on a web page; the length of time it will take to download the completed web page, and so forth.

The image consists of a background and the text of the words the user will hear. Alternatively, the text of the words may be contained in the final markup language document, rather than the image file, in which case the background consists only of the image representation. The background may be, for example, one or more scanned or digital photographs, scanned or digital artwork, or any combination thereof. Typically, the background has a thematic relationship to the text, or, the text and background may combine to tell a story. Designers will be concerned with size and placement of text, font type and color, and how the text interacts with the background, as well as the dimensions of the completed JPEG. It will be recognized that, although a JPEG image format is used for the background image in the preferred Flash implementation, alternative image formats may also be used and/or that the JPEG format may be superceded in the future.

The page is composed or drawn at step 1008, and digital representations of any photographs, artwork, or other images to be employed in creating the page background are acquired at step 1012.

The background image is converted, if necessary, to the JPEG file format at step 1016. It will be recognized that the page may be drawn or composed entirely in the digital domain and, in such case, scanning step 1012 may be omitted. It will be recognized that any computer drawing or graphic application may be used to create the JPEG image, including the Flash application itself. Where the JPEG is created within Flash, it does not need to be imported into Flash in step 1032, below. However, the use of a graphic editing application such as Adobe Photoshop or Illustrator will generally provide greater control over the background and produce higher quality images.

2. The MP3 Sound Files.

Sounds are recorded at step 1020 and converted to digital sound files at step 1024. The sound files are preferably skillfully recorded, edited and/or processed to produce high sound quality recordings and, advantageously, the speaker may receive supervision or training from a vocal coach to ensure proper vocal delivery. The speaker should be fluent in the spoken language, i.e., such that the diction and pronunciation would appear exemplary to a native speaker of the language. The playable words are recorded as distinct and separate words, even where the words appear as a part of an on-screen multiword phrase or sentence, e.g., and should be delivered with the intonation each word would have in the context of the phrase or sentence. Additionally, where multiple word phrases or sentences are provided and the fluency option is desired, a recording of the words spoken fluently as the entire phrase and sentence is also made.

Likewise, if there is a bilingual version, the primary language words, phrases and sentences must be spoken fluently. However, in certain embodiments, where words appear on screen as a multiword phrase or sentence and the bilingual option is desired, a single recording of the bilingual phrase or sentence is made, and bilingual recordings of the individual words forming part of a phrase or sentence need not be made. In certain embodiments, a speaker or speakers fluent in the on-screen language may be recorded to produce the audio files of the on-screen words, phrases, and/or sentences, and a different speaker or speakers fluent in the second language to produce the recordings of the bilingual text. However, it is also contemplated that the same speaker or speakers fluent in both languages may be used for both the on-screen and bilingual text.

The sound can be recorded onto an analog recording medium, such as analog tape, and subsequently transferred to a digital format. Exemplary digital file formats include but are not limited to 16-bit PCM, Direct Stream Digital (DSD) super audio CD format, waveform audio (WAV) format, G.711 mu-law, AIFF, XSNG, MPEG, MP3 audio, IMA/DVI ADPCM, GSM 06.10, InterWave VSC112, TrueSpeech 8.5, RealAudio, and other digital audio formats.

The recordings may be transmitted by suitable means directly from a compact disc or may be stored as digital data on some other digital storage device or medium such as a computer hard drive or digital magnetic tape. The sound recordings may be passed through a digital signal processing apparatus prior to storage in digital format, or may be recorded in digital format directly, i.e., obtained directly from the output of an analog-to-digital converter.

If the digital sound data is not already in MP3 audio format, any computer sound application can be used to transfer it into this format. In the preferred Flash implementation, all of the words that make up a given phrase or sentence that are to be separately playable are placed in a single MP3 file; thus there will be as many of these files as there are phrases or sentences. Each fluent and bilingual word (where the text appears on screen as a single word) or, in the case of multiword phrases or sentences, each fluent and bilingual phrase or sentence is placed in its own MP3 file.

It will be recognized that, although the MP3 audio format is employed for the sound files in the preferred Flash implementation, alternative audio formats may also be used and/or that the MP3 format may be superceded in the future.

3. The SWF File.

To achieve rollover sound, each playable text word on the web page is enclosed in a “hot” or sensitive region 318 (see, e.g., FIG. 3) that traps MouseOver events. In the preferred embodiment, the rollover sound is implemented using the Flash application because at this time Flash guarantees universal browser support. However, this effect may also be implemented by JavaScript, Java, Flash, and various other Web design applications.

As stated above, in the preferred Flash implementation, all words of a multiword phrase or sentence are contained as distinct and separate words in a single digital sound file where each separate and distinct word is selectively and individually playable.

In the Flash application, a Flash document is created (step 1036), which is sometimes referred to as a “movie.” At step 1032, the JPEG image is imported to the Flash document (if the JPEG was not created within Flash) and the MP3 audio files are imported into the document library. The JPEG is placed on one layer of the document and a separate layer is created for sound.

In the document library the developer creates a set of buttons and associates an imported MP3 audio file with each button. There will be one button for each playable word. For each button, the sound file is edited such that only the selected word plays, Effect is set to “None”, Sync to “Start”, and Loop to “0”. Each button is placed on the document sound layer, directly over the visual text word that will play it, and each button is made to allow transvisualization of the underlying word, and is preferably made transparent (i.e., Alpha is set to “0”).

A set of clickable buttons is created for the bilingual words, phrases, or sentences, where the bilingual functionality is desired. Each of the buttons is placed on the sound layer in an appropriate position with regard to its associated word, phrase, or sentence. Furthermore, where the fluency functionality is desired, a set of clickable buttons is created for the fluent phrases or sentences. Each of the buttons is placed on the sound layer in an appropriate position with regard to its associated phrase or sentence. Actions, such as underlining visible text, may also be associated with the fluent and/or bilingual buttons.

The Flash document or “movie” is tested at step 1040. After testing the document, one or more SWF files are published at step 1044, which may be embedded in an HTML page at step 1056. Multiple SWF files may be published from the same document or movie to produce a set of SWF files in which different fluency (step 1048) and bilingual (step 1052) features are turned on or off.

4. The HTML File.

Although the present invention is discussed by way of reference to HTML documents, it will be recognized that the present invention may be adapted to other markup languages and standards as currently exist or as may be promulgated in the future. Following the initial design of the web page (step 1004), the developer places one or more SWF files in an HTML file (step 1056) using the embedded data tags, <OBJECT> and <EMBED>. These tags cause the server to download the SWF file(s) along with the HTML file onto the client browser. The tags also cause the client browser to call the Flash player to play the SWF files. Program instructions, such as JavaScript or Java, may be used within the HTML file to load SWF files dynamically, depending on user interaction with the web page. Navigation features may also be added to the HTML file so that users can move from one speaking words web page to another. Text instruction for using the speaking words pages may also be provided in the HTML file and presented to the user, e.g., in the user's native language in the case of a bilingual or foreign language instruction implementation.

The developer may then test the HTML and SWF files locally at step 1060. If it is determined that additional modifications or debugging is necessary at step 1064, the process proceeds to step 1068 where it is determined whether the problem is an HTML problem or SWF problem. If the problem is not an HTML problem, the process returns to step 1036 and continues as described above. If the problem resides in the HTML file, the process returns to step 1056 and continues.

If no problems are revealed at step 1064, the HTML pages are published on the Internet (or other network) at step 1072 and tested at step 1076 on one or more the targeted platforms and, preferably, on a variety of platforms before releasing the final web pages at step 1080.

The following steps describe how to create a Web page in accordance with an alternate embodiment of the invention. The developer can use any application to create a JPEG or other image file. The image includes a background (e.g., digital or scanned photographs, digital or scanned art, or any combination thereof) and the text of the words the user will hear. Usually the background has a thematic relationship to the text, or the text and background tell a story. Alternatively, the text words can be contained in the final HTML markup rather than the JPEG file.

Next, spoken word sentence files are created. The spoken words, and native language translation, if applicable, may be prerecorded, e.g., on tape or CD in their individual sentence form. Each spoken word should remain distinct within the sentence. The developer may use any application to transfer the sentences into, e.g., AIFF audio format, making sure to keep the entire sentence intact in the AIFF file.

A sound-only SWF file is created in the Flash application by open a new movie and importing all of the AIFF sound files into its library. A layer for sound is created on the main timeline. To make the audio that will be played on mouse rollover, a new movie clip with three layers is created: labels, actions, and sound. A stop action is inserted on the first frame of the actions layer. A label is added to frame 5 of the labels layer; this label represents the “start” state of a sound. A stop sync sound command is added to frame 5 in the sound layer. One of the spoken word sentences is added to frame 6 of the sound layer. In the sound panel, Effect is set to “None,” Sync to “Start,” and Loop to “0.” In the Sound Editing Dialogue Box, only the first word in the spoken word sentence is selected and the Flash file is saved. Using the same procedure, movie clips are created for each word in the sentence. This is done for each word in each spoken word sentence. The process may be streamlined by duplicating movie clips and simply replacing the old sound with a new one.

To make the audio that will be played on mouse click (i.e., the translation of the spoken words or fluently spoken multiword phrases or sentences), the same process is used as for spoken words, but individual words are not selected. Instead, one movie clip is created for the whole sentence. Spoken words are played individually, but translations and fluent phrases/sentences are played as an entire sentence. A movie clip is created for each translation sentence.

An instance of each movie clip is placed on the stage. Each instance is named when placed. This name is used by the JavaScript code to pass the sound in the Flash player. Finally, a SWF file is generated by using the Publish command in Flash.

Next, the HTML file is created. The HTML file contains a JavaScript function that passes the appropriate sound to the Flash player and tells it to play. Spoken words are activated by a mouse rollover event. Translation/fluency sentences are activated by a mouse click event. If the text words have been incorporated into the image file, the JavaScript function to play the sound is called from a MAP statement. The MAP statement specifies the regions in which a rollover or click will play a particular sound instance. In the MAP statement, the developer must include the point coordinates that define an enclosing rectangle around the specific word to be played. If the image is background only and the text words exist in the HTML markup, the JavaScript function to play the sound is called from an HREF statement. In this case, it is not necessary to specify an enclosing rectangle because the word is automatically sensitive.

The present invention may also be employed as a standalone SWF file. A background containing an image and on-screen text representations of the words to be spoken and corresponding audio files are created as described above. Using the Flash application, a new movie file is created with two layers on its main timeline: JPEG and sound. The JPEG layer is selected and the JPEG file is imported, positioning it at the center of the stage. Then, the sound files are imported into the library. A button is created for each spoken word, and an optional button is created for each multiword phrase or sentence and for each standalone word that is not part of a multiword phrase or sentence. Likewise, an optional button for fluent playback of each multiword phrase or sentence in the on-screen language may also be provided.

For each spoken word button, in the Sound panel, the appropriate sentence is assigned to the button's “Over” state. The Sound panel is used to set the Effect to “None,” the Sync to “Start,” and the Loop to “0.” The Sound Editing Dialogue Box is used to select the appropriate word from the sentence. For each translation/bilingual sentence, the entire sentence is assigned to the button's “Down” state.

The sound layer is selected in the main timeline and an instance of each spoken word button is dragged to the appropriate text word. An instance of each translation/fluency button is dragged to the appropriate translation region, which can he represented by a dot or other on-screen icon, graphic, or indicia, at an on-screen position proximate the associated on-screen text, for example, 10 pixels to the left or right of the word or sentence. The movie may be tested to see that the audio is correctly placed. Finally, the completed movie is published as a SWF file that will play directly on the user's desktop.

Although the invention has been described with a certain degree of particularity, it should be recognized that elements thereof may be altered by persons skilled in the art without departing from the spirit and scope of the invention. One of the embodiments of the invention can be implemented as sets of instructions resident in the main memory 204 of one or more computer systems configured generally as described in FIG. 2. Until required by the computer system, the set of instructions may be stored in another computer readable memory such as the auxiliary memory of FIG. 2, for example in a hard disk drive or in a removable memory such as an optical disk for utilization in a DVD-ROM or CD-ROM drive, a magnetic media for utilization in a magnetic media drive, a magneto-optical disk for utilization in a magneto-optical drive, a floptical disk for utilization in a floptical drive, or a memory card for utilization in a card slot. Further, the set of instructions can be stored in the memory of another computer and transmitted over a local area network or a wide area network, such as the Internet, when desired by the user. Additionally, the instructions may be transmitted over a network in the form of an applet that is interpreted after transmission to the computer system rather than prior to transmission. One skilled in the art would appreciate that the physical storage of the sets of instructions or applets physically changes the medium upon which it is stored electrically, magnetically, chemically, physically, optically, or holographically, so that the medium carries computer readable information.

1. A computer-based language instruction system, comprising:
a processor for executing a language instruction program;
a video display device including a display screen for displaying a word in a first language for audible playback on the display screen;
a pointing device for controlling a cursor movable on the display screen of the video display device in response to a user operating the pointing device;
an audio output device;
a digital recording of said word for playback;
a memory for storing said digital recording;
a rollover region on the display screen associated with said word for playback and defined at a position on the display screen selected from a position overlapping a position of said word and a position visually associated with said word, said rollover region configured to cause audible playback of said word in said first language when at least a portion of the cursor is moved over the rollover region;
an on-screen object selectable with said pointing device and associated with said word displayed on said display screen; and
said on-screen object configured to trigger audio playback of said displayed word in a second language different from the first language.

2. The system of claim 1, wherein the rollover region is not visible to the user.

3. The system of claim 1, wherein the rollover region is substantially contiguous with a set of pixels occupied by said word on the display screen.

4. The system of claim 1, wherein said language instruction program is a web-based language instruction program.

5. The system of claim 1, wherein the first language is a new language to be learned by the user and the second language is a primary language of the user.

6. The system of claim 1, wherein said displayed word is part of a multiword phrase or sentence in said first language appearing on said display screen.

7. The system of claim 6, wherein each word of said multiword phrase or sentence is individually selectable with the pointing device.

8. A computer-based language instruction system, comprising;
a processor for executing a language instruction program;
a video display device including a display screen for displaying a word in a first language for audible playback on the display screen, wherein said word is part of a multiword phrase or sentence;
a pointing device for controlling a cursor movable on the display screen of the video display device in response to a user operating the pointing device;
an audio output device:
a digital recording of said word for playback;
a memory for storing said digital recording;
a rollover region on the display screen associated with said word for playback and defined at a position on the display screen selected from a position overlapping a position of said word and a position visually associated with said word, said rollover region configured to cause audible playback of said word in said first language when at least a portion of the cursor is moved over the rollover region;
a first on-screen object selectable with said pointing device and associated with said multiword phrase or sentence displayed on said display screen, said first on-screen object configured to trigger audio playback of said multiword phrase or sentence in said first language; and
a second on-screen object selectable with said pointing device and associated with said multiword phrase or sentence displayed on said display screen, said second on-screen object configured to trigger audio playback of said multiword phrase or sentence in a second language different from said first language.

9. The system of claim 8, wherein each word of said multiword phrase or sentence is individually selectable with said pointing device.

10. The system of claim 9, wherein all words of said multiword phrase or sentence are contained in a single digital audio file.

11. The system of claim 8, wherein said language instruction program is a web-based language instruction program.

12. The system of claim 1, further comprising:
a plurality of displayed words for playback appearing on said display screen, said plurality of displayed words appearing as individual words, multiword phrases or sentences, or a combination thereof; and
a distinct rollover region associated with each of said words, each distinct rollover region defined at a position on the display screen overlapping a position on the display screen of said word with which the rollover region is associated and configured to cause audible playback of said word in said first language when at least a portion of the cursor is over the rollover region.

13. The system of claim 12, wherein audible playback of a word is suppressed when at least a portion of the cursor moves over the rollover region during a time in which said audio output device is already causing audible playback.

14. The system of claim 1, further comprising an on-screen visual cue which appears during audible playback.

15. The system of claim 1, wherein the pointing device is a transparent touch screen overlaying said display screen.

16. A computer-based language instruction system, comprising:
a processor for executing a language instruction program;
a video display device including a display screen for displaying a word in a first language for audible playback on the display screen;
a pointing device for controlling a cursor movable on the display screen of the video display device in response to a user operating the pointing device;
an audio output device;
a digital recording of said word for playback;
a memory for storing said digital recording;
a rollover region on the display screen associated with said word for playback, said rollover region configured to cause audible playback of said word in said first language when at least a portion of the cursor is moved over the rollover region; and
said rollover region selected from;
a region defined by a rectangular box equal in size to and enclosing said word; and
a region defined by a rectangular box with top and side boundaries that are aligned with the top and sides of said word and a bottom boundary that extends a predetermined number of pixels below the bottom of said word.

17. In a computer-based information handling system having a video display, an audio output device for audio output of prerecorded sounds, a pointing device for positioning a cursor on the video display, a method of providing language instruction to a student, the method comprising the computer-implemented steps of:
providing an interface for displaying a word in a first language on the video display;
prerecording a digital sound recording of said word being spoken in said first language;
associating a designated hot region on the video display for triggering audio output of the recording of said word in the first language, said hot region defined at a position on the video display selected from a location which at least partially overlies said word on the video display and a location visually associated with said word;
positioning at least a portion of the cursor over the hot region in response to a user using the pointing device;
causing the audio output device to audibly output the recording of said word in the first language, the audio output being caused by the cursor being positioned over the hot region;
providing an on-screen object selectable with said pointing device and associated with said word displayed on said display screen; and
said on-screen object configured to trigger audio playback of said displayed word in a second language different from the first language.

18. A computer-readable medium whose contents cause a computer-based information handling system to perform method steps for audio playback of a word appearing on a display device of said information handling system, said method steps comprising:
providing an interface for displaying a word in a first language on the video display;
prerecording a digital sound recording of said word being spoken in said first language;
associating a designated hot region on the display device for triggering audio output of the recording of said word in the first language, said hot region defined at a position on the video display selected from a location which at least partially overlies said word on the video display and a location visually associated with said word;
positioning at least a portion of the cursor over the hot region in response to a user using a pointing device for causing movement of a cursor on the display device;
causing the audio output device to audibly output the recording of said word in the first language, the audio output being caused by the cursor being positioned over the hot region;
providing an on-screen object selectable with said pointing device and associated with said word displayed on said display screen; and
said on-screen object configured to trigger audio playback of said displayed word in a second language different from the first language.

19. The system of claim 4, further comprising:
an HTML page comprising an embedded web object, said embedded web object for playing said digital recording of said word for playback.

20. A method for developing a language instruction system, comprising:
designing a spoken words interface including one or more words in viewable form;
creating a digital sound recording of said one or more words for audible playback;
for each of said one or more words, defining a rollover region on said spoken words interface and associating at least a portion of said digital sound recording with each rollover region so as to cause audible playback of at least a portion of said digital sound recording in response to user input comprising positioning at least a portion of an on-screen cursor over the rollover region;
each rollover region defined on the spoken words interface at an on-screen location selected from a location which at least partially overlies an on-screen location of an associated one of said one or more words, and a location visually associated with said word;
creating a set of one or more user selectable on-screen objects for triggering bilingual playback of said one or more words;
associating each of said on-screen objects with a selected one or group of said one or more words and placing each of said one or more on-screen objects on the spoken words interface proximate the selected one or group of said one or more words; and
optionally, creating an action viewable on a display screen by a user and associating said action with said one or more on-screen objects.

21. A method for developing a language instruction system, comprising:
designing a spoken words interface comprising a background image and text of one or more words for audible playback;
creating a digital image representation of the background;
creating a digital sound recording of said one or more words for audible playback;
for each of said one or more words, defining a rollover region on said spoken words interface and associating at least a portion of said digital sound recording with each rollover region so as to cause audible playback of at least a portion of said digital sound recording in response to user input comprising positioning at least a portion of an on-screen cursor over the rollover region;
each rollover region defined on the spoken words interface at an on-screen location selected from a location which at least partially overlies an on-screen location of an associated one of said one or more words, and a location visually associated with said word;
creating a FLASH document including said background image and said digital sound recording
creating a FLASH format (SWF) from the FLASH document.

22. The method of claim 21, further comprising:
prior to creating the SWF file, testing the FLASH document.

23. The method of claim 22, further comprising embedding the SWF file as an object in said HTML page and, optionally:
testing the HTML page on one or more targeted platforms; and
publishing the HTML page on the web.

24. The method of claim 21, wherein the background is selected from one or more of scanned photographs, digital photographs, scanned artwork, and digital artwork, or any combination thereof.

25. The method of claim 21, wherein the background bears a thematic relationship to the text and/or the text and background combine to tell a story.

26. The method of claim 20, further comprising:
said spoken words interface including a background image and text of said one or more words; and
creating a digital image representation of the background;

27. The method of claim 20, wherein said one or more words includes a multiword phrase or sentence, said method further comprising:
creating a digital sound recording of said multiword phrase or sentence being spoken in a fluent manner;
creating an on-screen object for triggering playback of said digital sound recording of said multiword phrase or sentence;
associating said on-screen object with said multiword phrase or sentence and placing the object on the spoken words interface proximate said multiword phrase or sentence; and
optionally, creating an action viewable on a display screen by a user and associating said action with on-screen object.

28. The method of claim 20, wherein the rollover region includes human-viewable indicia which allows transvisualization of the word.

29. The method of claim 28, wherein the rollover region is transparent.

30. A markup language document stored on a computer-readable medium to provide interactive language instruction, comprising:
a word in a first language viewable on a video display;
a rollover region on the video display for triggering audio playback of a prerecorded digital recording of said word in the first language in response to a user moving at least a portion of an on-screen cursor over said rollover region, said rollover region selected from a position overlapping a position of said word and a position visually associated with said word on the video display;
an on-screen object selectable with said pointing device and associated with said word displayed on said display screen; and
said on-screen object configured to trigger audio playback of said displayed word in a second language different from the first language.

31. The markup language document of claim 30, further comprising one or both of:
an embedded object embedded in said markup language document said embedded object including said prerecorded digital sound recording; and
a background image viewable on the video display and including said word in said first language.

32. The method of claim 20, further comprising:
embedding an HTML object for playing said digital sound recording in an HTML page.

33. The system of claim 19, wherein said embedded web object is a SWF file and said digital recording is an MP3 file.

34. The method of claim 17, further comprising:
creating a web object including said digital sound recording; and
embedding said web object in an HTML page.

35. The system of claim 10, further comprising:
an HTML page including an embedded web object, said embedded web object for playing said digital recording.

36. The method of claim 21, further comprising:
storing said background image and said digital sound recording into a document library of said FLASH document;
placing said background image on a first layer of said document; and
placing said digital sound recording on a second layer of said document.
